(19) United States
(12) Patent Application Publication
(10) Pub. No.: US 2008/0176475 A1
(43) Pub. Date: Jul. 24, 2008

(54) Wettable polyester fibers and fabrics

(76) Inventors: Suhas D. Sahasrabudhe, Mumbai (IN); Paragkumar N. Thanki, Mumbai (IN); Archana K. Desai, Mumbai (IN); Vinayak M. Kavitkar, Mumbai (IN); Matthew E. Gande, Norwalk, CT (US); Andrew J. Leggio, Franklin Square, NY (US); Ashutosh H. Sharma, Wappingers Falls, NY (US)

Correspondence Address: JoAnn Villamizar;Ciba Corporation/Patent Department, 540 White Plains Road, P.O. Box 2005, Tarrytown, NY, 10591, US

(21) Appl. No.: 12/009,890

(22) Filed: Jan. 23, 2008

Related U.S. Application Data
(60) Provisional application No. 60/897,068, filed on Jan. 24, 2007.

(51) Int. Cl. D04H 13/00; D03D 15/00; B29C 47/00; C08K 5/41

(52) U.S. Cl. 442/414; 442/181; 264/176.1; 524/166

(57) ABSTRACT

The present invention is aimed at a method of providing wettability to polyester fibers or filaments, to woven or nonwoven fabrics made therefrom and to resultant articles of manufacture. The method comprises melt extruding a mixture comprising a polyester and one or more additives selected from the group consisting of
a) phenylalkyl-oxy-alkyl metal sulfonates of the formula

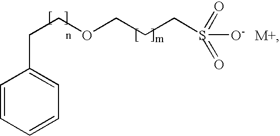

b) alkyl-oxy-alkyl metal sulfonates of the formula

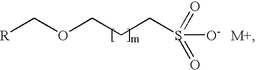

c) polyethyleneoxy-alkyl metal sulfonates of the formula

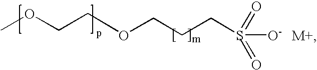

d) alkyl-polyethyleneoxy-alkyl metal sulfonates of the formula

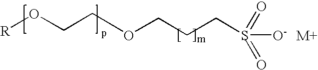

and
e) alkyl-1,2-disulfonate metal sulfonates

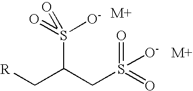

where m is 0, 1 or 2, n is an integer from 1 to 6, p is an integer from 1 to 16, R is alkyl of 1 to 24 carbon atoms and M is Na, K or Li. into a plurality of fibers or filaments and cooling the fibers or filaments.

This application claims benefit of U.S. provisional app. No. 60/897,068, filed Jan. 24, 2007, the contents of which are incorporated by reference.

The present invention relates to a method of providing polyester knit, woven or nonwoven fabrics with durable wettability and to the articles of manufacture prepared therefrom.

### BACKGROUND

U.S. Pat. No. 4,357,390 teaches hollow polyester fibers with antistatic properties.

U.S. Pat. No. 4,351,738 teaches polyester filamentary yarns for high-speed friction draw-false twist texturing.

U.S. Pat. No. 4,666,764 discloses an antistatic polyester fabric having water repellency.

JP08060488, JP08260343, JP08260344, JP08260349, JP09077963, JP10025623 and JP58081616 disclose polyester fibers or fabrics with certain desirable properties.

ZA6606302 is aimed at the dyeability of fabrics.

It has surprisingly been found that melt blending polyester with certain phenylalkyl-oxy-alkyl metal sulfonates, alkyl-oxy-alkyl metal sulfonates or polyethyleneoxy-alkyl metal sulfonates, and extruding the mixture into fibers, provides for polyester fibers or filaments with durable wettability and superior moisture management properties.

### SUMMARY OF THE INVENTION

Disclosed is a wettable polyester fiber or filament,

which polyester fiber or filament comprises a melt blend of a polyester and one or more compounds selected from the group consisting of

a) phenylalkyl-oxy-alkyl metal sulfonates of the formula

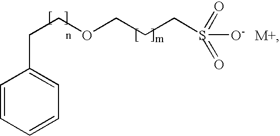

b) alkyl-oxy-alkyl metal sulfonates of the formula

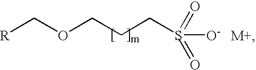

c) polyethyleneoxy-alkyl metal sulfonates of the formula

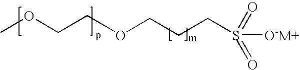

d) alkyl-polyethyleneoxy-alkyl metal sulfonates of the formula

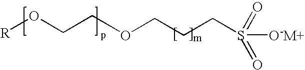

and

e) alkyl-1,2-disulfonate metal sulfonates

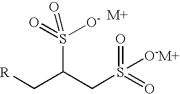

where

m is 0, 1 or 2,

n is an integer from 1 to 6,

p is an integer from 1 to 16,

R is alkyl of 1 to 24 carbon atoms and

M is Na, K or Li.

Also disclosed is a method for imparting wettability to a polyester fiber or filament,

which method comprises melt extruding a mixture which comprises

a polyester and one or more compounds selected from the group consisting of components a), b), c), d) and e)

into a plurality of fibers or filaments and cooling the fibers or filaments.

### DETAILED DISCLOSURE

The present methods produce fibers or filaments, which are knitted, woven or bonded into knit, woven or nonwoven fabrics respectively.

The present melt extrusion methods form fibers or filaments. In accordance with known technology such as continuous filament spinning for yarn or staple fiber, and nonwoven processes such as spunbond production and meltblown production, the fibers or filaments are formed by extrusion of the molten polymer through small orifices. In general, the fibers or filaments thus formed are then drawn or elongated to induce molecular orientation and affect crystallinity, resulting in a reduction in diameter and an improvement in physical properties. In nonwoven processes such as spunbonding and meltblowing, the fibers or filaments are directly deposited onto a foraminous surface, such as a moving flat conveyor and are at least partially consolidated by any of a variety of bonding means. It is known to those skilled in the art to combine processes or the fabrics from different processes to produce composite fabrics which possess certain desirable characteristics. Examples of this are combining spunbond and meltblown to produce a laminate fabric. Additionally either or both of these processes may be combined in any arrangement with a staple fiber carding process or bonded fabrics resulting from a nonwoven staple fiber carding process. In such described laminate fabrics, the layers are generally at least partially consolidated.

The invention is also applicable to melt extruded bi-component fibers, wherein one of the components is a polyester according to this invention.

Nonwoven fabrics of polyester may have a carded fiber structure or comprise a mat in which the fibers or filaments are distributed in a random array. The fabric may be formed and bonded by any one of numerous known processes including hydroentanglement or spun-lace techniques, or by air laying or melt-blowing filaments, batt drawing, stitchbonding, etc., depending upon the end use of the article to be made from the fabric.

Thermoplastic polyester fibers are typically extruded at temperatures in the range of from about 285° to about 300° C.

According to the present invention, one or more compounds of components a), b), c), d) and e) are incorporated into a thermoplastic polyester, such as polyethylene terephthalate, in the melt, and are extruded with the polyester into the form of fibers and filaments which are then quenched, attenuated and formed into fabrics, either in a subsequent or concomitant processing step.

The term “wettable” means provided with hydrophilicity. The additives a), b), c), d) and e) are hydrophilic additives.

The compounds of components a), b), c), d) and e) may be compounded with the polymer pellets which are to be melt extruded. To improve processing, the compound may be preformulated or compounded into a polyester which may also contain a filler, such as talc, and other traditional stabilizers.

The mixing of the compounds of components a), b), c), d) and e) is done by mixing them into molten polymer by commonly used techniques such as roll-milling, mixing in a Banbury type mixer, or mixing in an extruder barrel and the like. The heat history (time at which held at elevated temperature) can be shortened by mixing the compounds of a), b), c), d) and e) with unheated polymer particles so as to achieve substantially even distribution of the agent in the mass of polymer, thereby reducing the amount of time needed for intensive mixing at molten temperature.

Conveniently, the compounds of components a), b), c), d) and e) can also be added substantially simultaneously or sequentially with any other additives which may be desired in certain instances. The compounds of a), b), c), d) and e) may also be preblended with other additives and the blend then added to the polymer. It is contemplated that in some instances the compounds of a), b), c), d) and e) may have the additional benefit of aiding the other additives to become more easily or evenly dispersed or dissolved in the polyester. For easier batch-to-batch control of quality, it may be preferred to employ concentrated masterbatches of polymer/additive blends which are subsequently blended, as portions, to additional quantities of polymer to achieve the final desired formulation. The masterbatch, or the neat additives, may be injected into freshly prepared polymer while the polymer is still molten and after it leaves the polymerization vessel or train, and blended therewith before the molten polymer is chilled to a solid or taken to further processing.

Accordingly, also disclosed is a present method which comprises

preparing a masterbatch comprising one or more compounds of components a), b), c), d) and e) and a polymer and

melt extruding a mixture which comprises said masterbatch and a polyester

into a plurality of fibers or filaments and cooling the fibers or filaments.

The present masterbatch, or concentrate, contains the compounds of components a), b), c), d) and e) in a concentration of, for example, about 1% to about 75%, from about 2% to about 50% or from about 5% to about 40% by weight incorporated in a polymer.

The masterbatch polymer may be polyester or it may be some other thermoplastic polymer.

The additive compounds of components a), b), c), d) and e), in total, are present in the methods of this invention from about 0.05% to about 5.0% by weight, based on the total weight of the polyester. For example, the alkyl metal sulfonates are present from about 0.1% to about 3.7%, from about 0.25% to about 3.2%, from about 0.5% to about 2.7%, from about 0.4% to about 2.7%, from about 0.3% to about 2.7%, based on the total weight of polyester. For instance, the present alkyl metal sulfonates are present at levels of about 0.2%, 0.3%, 0.5%, 0.75%, 1.0%, 2.0%, 2.5%, 3.5% or about 4.5%, based on the total weight of the polyester.

The incorporation of one or more additive compounds of components a), b), c), d) and e) into a polyester fiber or filament according to the present invention results in observed improved wettability of these materials. This modification is also durable, such that the fibers or filaments and fabrics made therefrom do not lose their wettability upon aging or handling. The improved wettability is resistant to repeated insults, even over extended time periods.

The present invention is aimed at nonwoven fabrics, for example polyester fabrics. It is also aimed at threads or yarns for weaving or knitting in conventional textile processes.

The compounds of components a), b), c), d) and e) of the present invention are effective irrespective of other factors that influence the properties of nonwoven fabrics, for example, basis weight, fiber diameter, degree and type of bonding of the fibers, and the synergistic effects and influence of composite structures.

The present invention is not limited to single-component fibers. Polyester bi-component fibers, particularly side-by-side or sheath-core fibers would be expected to demonstrate the same practical benefits as single component fibers. It may be particularly efficacious to include the melt additive only in a single polyester component.

The present methods may be employed for hollow polyester fibers, for example as disclosed in U.S. Pat. Nos. 4,357,390 and 4,666,764, the relevant disclosures of which are hereby incorporated by reference. The disclosure of U.S. Pat. No. 4,351,738 is also incorporated by reference. The present invention is not limited to round or hollow cross sections, but would also be effective in other cross sections such as delta, tri-lobal, etc.

The fabrics of the present invention may be sterilized by exposure to about 0.5 to about 10 megarads of gamma irradiation. Sterilization with gamma irradiation is employed for hospital garments and the like.

Polyester woven and nonwoven fibers and fabrics prepared according to the present invention also exhibit exceptional printability.

The present fibers and fabrics according to this invention have excellent softness.

The polyester has dicarboxylic acid repeat units selected from the group consisting of aromatic dicarboxylic acids having 8 to 14 carbon atoms, aliphatic dicarboxylic acids having 4 to 12 carbon atoms, cycloaliphatic dicarboxylic acids having 8 to 12 carbon atoms, and mixtures thereof.

For instance such diacids are terephthalic acid, isophthalic acid, o-phthalic acid, naphthalene dicarboxylic acid, cyclohexane dicarboxylic acid, cyclohexanediacetic acid, diphenyl-4,4′-dicarboxylic acid, succinic acid, maleic acid, glutaric acid, adipic acid, sebacic acid and mixtures thereof.

For example diacids are terephthalic acid, isophthalic acid and 2,6-naphthalene dicarboxylic acid.

The diol or glycol portion of the polyester are derived from the generic formula HO-G-OH where G is an aliphatic, cycloaliphatic or aromatic moiety of 2 to 18 carbon atoms.

For example such diols or glycols are ethylene glycol, diethylene glycol, triethylene glycol, propane-1,3-diol, propane-1,2-diol, butane-1,4-diol, pentane-1,5-diol, hexane-1,6-diol, 1,4-cyclohexanedimethanol, 3-methylpentane-2,4-diol, 2-methylpentane1,4-diol, 2,2-diethyl-propane-1,3-diol, 1,4-di-(hydroxyethoxy)benzene, 2,2-bis(4-hydroxycyclohexyl)-propane, 2,4-dihydroxy-1,1,3,3-tetramethylcyclobutane, 2,2-bis-(3-hydroxyethoxyphenyl)propane, 2,2-bis-(4-hydroxypropoxyphenyl)ethane and mixtures thereof.

The diol is for example ethylene glycol or 1,4-cyclohexanedimethanol.

The polyester is for example poly(ethylene terephthalate) PET or poly(ethylene2,6-naphthalene-2,6-dicarboxylate) PEN or poly(lactic acid) PLA.

It is also contemplated that the polyester can also be a blend of polyesters or copolyesters including components mentioned above.

It is further contemplated that polymeric substrates other than polyester are provided with outstanding wettability with the present alkyl metal sulfonates. For example polyolefins or polyamides. For example polypropylene, polyethylene or copolymers or mixtures thereof. For example polyamide 6,6. For example, woven or non-woven fabrics made of these substrates is also contemplated.

Alkyl having up to 24 carbon atoms is a branched or unbranched radical, for example methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl, icosyl or docosyl.

It is also contemplated that other gegenions besides Na, K or Li are suitable in the alkyl metal sulfonate. For example ammonium or mono-, di-, tri- or tetra-alkyl ammonium ions. For example alkali metal cations, alkaline earth metal cations or an aluminium cation, for example magnesium, calcium or aluminium ions.

The compositions prepared by the methods of the invention may optionally also contain from about 0.01 to about 10%, preferably from about 0.025 to about 5%, and especially from about 0.1 to about 3% by weight of various conventional stabilizer coadditives, such as the materials listed below, or mixtures thereof.

1. Antioxidants

1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1-methylundec-1-yl)phenol, 2,4-dimethyl-6-(1-methylheptadec-1-yl)phenol, 2,4-dimethyl-6-(1-methyltridec-1-yl)phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

1.3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis-(3,5-di-tert-butyl-4-hydroxyphenyl) adipate.

1.4. Tocopherols, for example α-tocopherol, β-tocopherol, γ-tocopherol, δ-tocopherol and mixtures thereof (Vitamin E).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis-(3,6-di-sec-amylphenol), 4,4′-bis(2,6-dimethyl-4-hydroxyphenyl)disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3-tert-butyl-4-hydroxyphenyl)butyrate], bis(3-tert-butyl-4-hydroxy-5-methyl-phenyl)dicyclopentadiene, bis[2-(3′tert-butyl-2-hydroxy-5-methylbenzyl)-6-tert-butyl-4-methylphenyl]terephthalate, 1,1-bis-(3,5-dimethyl-2-hydroxyphenyl)butane, 2,2-bis-(3,5-di-tert-butyl-4-hydroxyphenyl)propane, 2,2-bis-(5-tert-butyl-4-hydroxy2-methylphenyl)-4-n-dodecylmercaptobutane, 1,1,5,5-tetra-(5-tert-butyl-4-hydroxy-2-methylphenyl)pentane.

1.7. Benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, 1,3,5-tri-(3,5-di-tert-butyl-4-hydroxybenzyl)-2,4,6-trimethylbenzene, di-(3,5-di-tert-butyl-4-hydroxybenzyl)sulfide, 3,5-di-tert-butyl-4-hydroxybenzyl-mercapto-acetic acid isooctyl ester, bis-(4-tert-butyl-3-hydroxy-2,6-dimethylbenzyl)dithiol terephthalate, 1,3,5-tris-(3,5-di-tert-butyl-4-hydroxybenzyl)isocyanurate, 1,3,5-tris-(4-tert-butyl-3-hydroxy-2,6-dimethylbenzyl)isocyanurate, 3,5-di-tert-butyl-4-hydroxybenzyl-phosphoric acid dioctadecyl ester and 3,5-di-tert-butyl-4-hydroxybenzyl-phosphoric acid monoethyl ester, calcium-salt.

1.8. Hydroxybenzylated malonates, for example dioctadecyl-2,2-bis-(3,5-di-tert-butyl-2-hydroxybenzyl)-malonate, di-octadecyl-2-(3-tert-butyl-4-hydroxy-5-methylbenzyl)-malonate, di-dodecylmercaptoethyl-2,2-bis-(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,3,5-tris-(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris-(3,5-di-tert-butyl-4-hydroxyphenoxy)-1,2,3-triazine, 1,3,5-tris-(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxy-lauric acid anilide, 4-hydroxy-stearic acid anilide, 2,4-bis-octylmercapto-6-(3,5-tert-butyl-4-hydroxyanilino)-s-triazine and octyl-N-(3,5-di-tert-butyl-4-hydroxyphenyl)-carbamate.

1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxamide, 3-thiaundecanol, 3-thiapentadecanol, trimethylhexanediol, trimethyl-olpropane, 4-hydroxymethyl-1-phospha-2,6,7-trioxabicyclo[2.2.2]octane.

1.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1 supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenlenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyidiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octylphenothiazines, N-allylphenothiazin, N,N,N′,N′-tetraphenyl-1,4-diaminobut-2-ene, N,N-bis-(2,2,6,6-tetramethyl-piperid-4-yl-hexamethylenediamine, bis(2,2,6,6-tetramethylpiperid-4-yl)-sebacate, 2,2,6,6-tetramethylpiperidin-4-one, 2,2,6,6-tetramethylpiperidin-4-ol.

2. UV Absorbers and Light Stabilizers

2.1. 2-(2-Hydroxyphenyl)-2H-benzotriazoles, for example known commercial hydroxyphenyl-2H-benzotriazoles and benzotriazoles as disclosed in, U.S. Pat. Nos. 3,004,896; 3,055,896; 3,072,585; 3,074,910; 3,189,615; 3,218,332; 3,230,194; 4,127,586; 4,226,763; 4,275,004; 4,278,589; 4,315,848; 4,347,180; 4,383,863; 4,675,352; 4,681,905, 4,853,471; 5,268,450; 5,278,314; 5,280,124; 5,319,091; 5,410,071; 5,436,349; 5,516,914; 5,554,760; 5,563,242; 5,574,166; 5,607,987 and 5,977,219, such as 2-(2-hydroxy-5-methylphenyl)-2H-benzotriazole, 2-(3,5-di-t-butyl-2-hydroxyphenyl)-2H-benzotriazole, 2-(2-hydroxy-5-t-butylphenyl)-2H-benzotriazole, 2-(2-hydroxy-5-t-octylphenyl)-2H-benzotriazole, 5-chloro-2-(3,5-di-t-butyl-2-hydroxyphenyl)-2H-benzotriazole, 5-chloro-2-(3-t-butyl-2-hydroxy-5-methylphenyl)-2H-benzotriazole, 2-(3-sec-butyl-5-t-butyl-2-hydroxyphenyl)-2H-benzotriazole, 2-(2-hydroxy-4-octyloxyphenyl)-2H-benzotriazole, 2-(3,5-di-t-amyl-2-hydroxyphenyl)-2H-benzotriazole 2-(3,5-bis-α-cumyl-2-hydroxyphenyl)-2H-benzotriazole, 2-(3-t-butyl-2-hydroxy-5-(2-(ω-hydroxy-octa-(ethyleneoxy)carbonyl-ethyl)-, phenyl)-2H-benzotriazole, 2-(3-dodecyl-2-hydroxy-5-methylphenyl)-2H-benzotriazole, 2-(3-t-butyl-2-hydroxy-5-(2-octyloxycarbonyl)ethylphenyl)-2H-benzotriazole, dodecylated 2-(2-hydroxy-5-methylphenyl)-2H-benzotriazole, 2-(3-t-butyl-2-hydroxy-5-(2-octyloxycarbonylethyl)phenyl)-5-chloro-2H-benzotriazole, 2-(3-tert-butyl-5-(2-(2-ethylhexyloxy)-carbonylethyl)-2-hydroxyphenyl)-5-chloro-2H-benzotriazole, 2-(3-t-butyl-2-hydroxy-5-(2-methoxycarbonylethyl)phenyl)-5-chloro-2H-benzotriazole, 2-(3-t-butyl-2-hydroxy-5-(2-methoxycarbonylethyl)phenyl)-2H-benzotriazole, 2-(3-t-butyl-5-(2-(2-ethylhexyloxy)carbonylethyl)-2-hydroxyphenyl)-2H-benzotriazole, 2-(3-t-butyl-2-hydroxy-5-(2-isooctyloxycarbonylethyl)phenyl-2H-benzotriazole, 2,2′-methylene-bis(4-t-octyl-(6-2H-benzotriazol-2-yl)phenol), 2-(2-hydroxy-3-α-cumyl-5-t-octylphenyl)-2H-benzotriazole, 2-(2-hydroxy-3-t-octyl-5-α-cumylphenyl)-2H-benzotriazole, 5-fluoro-2-(2-hydroxy-3,5-di-α-cumylphenyl)-2H-benzotriazole, 5-chloro-2-(2-hydroxy-3,5-di-α-cumylphenyl)-2H-benzotriazole, 5-chloro-2-(2-hydroxy-3-α-cumyl-5-t-octylphenyl)-2H-benzotriazole, 2-(3-t-butyl-2-hydroxy-5(2-isooctyloxycarbonylethyl)phenyl)-5-chloro-2H-benzotriazole, 5-trifluoromethyl-2-(2-hydroxy-3-α-cumyl-5-t-octylphenyl)-2H-benzotriazole, 5-trifluoromethyl-2-(2-hydroxy-5-t-octylphenyl)-2H-benzotriazole, 5-trifluoromethyl-2-(2-hydroxy-3,5-di-t-octylphenyl)-2H-benzotriazole, methyl 3-(5-trifluoromethyl-2H-benzotriazol-2-yl)-5-t-butyl-4-hydroxyhydrocinnamate, 5-butylsulfonyl-2-(2-hydroxy-3-α-cumyl-5-t-octylphenyl)-2H-benzotriazole, 5-trifluoromethyl-2-(2-hydroxy-3-α-cumyl-5-t-butylphenyl)-2H-benzotriazole, 5-trifluoromethyl-2-(2-hydroxy-3,5-di-t-butylphenyl)-2H-benzotriazole, 5-trifluoromethyl-2-(2-hydroxy-3,5-di-α-cumylphenyl)-2H-benzotriazole, 5-butylsulfonyl-2-(2-hydroxy-3,5-di-t-butylphenyl)-2H-benzotriazole and 5-phenylsulfonyl-2-(2-hydroxy-3,5-di-t-butylphenyl)-2H-benzotriazole.

2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, as for example 4-tertbutylphenyl salicylate, phenyl salicylate, octylphenyl salicylate, dibenzoyl resorcinol, bis(4-tert-butylbenzoyl) resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4. Acrylates and malonates, for example, α-cyano-β,β-diphenylacrylic acid ethyl ester or isooctyl ester, α-carbomethoxy-cinnamic acid methyl ester, α-cyano-β-methyl-p-methoxy-cinnamic acid methyl ester or butyl ester, α-carbomethoxy-p-methoxy-cinnamic acid methyl ester, N-(β-carbomethoxy-β-cyanovinyl)-2-methyl-indoline, Sanduvor® PR25, dimethyl p-methoxybenzylidenemalonate (CAS#7443-25-6), and Sanduvor® PR31, di-(1,2,2,6,6-pentamethylpiperidin-4-yl)p-methoxybenzylidenemalonate (CAS #147783-69-5).

2.5. Nickel compounds, for example nickel complexes of 2,2′-thio-bis-[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenyl undecylketoxime, nickel complexes of 1-phenyl-4-lauroyl-5-hydroxypyrazole, with or without additional ligands.

2.6. Sterically hindered amine stabilizers, for example 4-hydroxy-2,2,6,6-tetramethylpiperidine, 1-allyl-4-hydroxy-2,2,6,6-tetramethylpiperidine, 1-benzyl-4-hydroxy-2,2,6,6-tetramethylpiperidine, bis(2,2,6,6-tetramethyl-4-piperidyl) sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl)n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butane-tetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decan-2,4-dione, bis(1-octyloxy-2,2,6,6-tetramethylpiperidyl)sebacate, bis(1-octyloxy-2,2,6,6-tetramethylpiperidyl) succinate, linear or cyclic condensates of N,N′-bis-(2,2,6,6-tetramethyl-4-piperidyl)-hexamethylenediamine and 4-morpholino-2,6-dichloro-1,3,5-triazine, the condensate of 2-chloro-4,6-bis(4-n-butylamino-2,2,6,6-tetramethylpiperidyl )-1,3,5-triazine and 1,2-bis(3-amino-propylamino)ethane, the condensate of 2-chloro-4,6-di-(4-n-butylamino-1,2,2,6,6-pentamethylpiperidyl)-1,3,5-triazine and 1,2-bis-(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidin-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensation product of N,N′-bis(2,2,6,6-tetramethyl-4-piperidyl)hexamethylenediamine and 4-cyclohexylamino-2,6-dichloro-1,3,5-triazine, a condensation product of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); N-(2,2,6,6-tetramethyl-4-piperidyl)-n-dodecylsuccinimid, N-(1,2,2,6,6-pentamethyl-4-piperidyl)-n-dodecylsuccinimid, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro [4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, diester of 4-methoxy-methylene-malonic acid with 1,2,2,6,6-pentamethyl-4-hydroxypiperidine, poly[methylpropyl-3-oxy-4-(2,2,6,6-tetramethyl-4-piperidyl)]siloxane, reaction product of maleic acid anhydride-α-olefin-copolymer with 2,2,6,6-tetramethyl-4-aminopiperidine or 1,2,2,6,6-pentamethyl-4-aminopiperidine.

The sterically hindered amine may also be one of the compounds described in U.S. Pat. No. 5,980,783, the relevant parts of which are hereby incorporated by reference, that is compounds of component I-a), I-b), I-c), I-d), I-e), I-f), I-g), I-h), I-i), I-j), I-k) or I-l), in particular the light stabilizer 1-a-1, 1-a-2, 1-b-1, 1-c-1, 1-c-2, 1-d-1, 1-d-2, 1-d-3, 1-e-1, 1-f-1, 1-g-1, 1-g-2 or 1-k-1 listed on columns 64-72 of said U.S. Pat. No. 5,980,783.

The sterically hindered amine may also be one of the compounds described in U.S. Pat. Nos. 6,046,304 and 6,297,299, the disclosures of which are hereby incorporated by reference, for example compounds as described in claims 10 or 38 or in Examples 1-12 or D-1 to D-5 therein.

2.7. Sterically hindered amines substituted on the N-atom by a hydroxy-substituted alkoxy group, for example compounds such as 1-(2-hydroxy-2-methylpropoxy)-4-octadecanoyloxy-2,2,6,6-tetramethylpiperidine, 1-(2-hydroxy-2-methylpropoxy)-4-hexadecanoyloxy-2,2,6,6-tetramethylpiperidine, the reaction product of 1-oxyl-4-hydroxy-2,2,6,6-tetramethylpiperidine with a carbon radical from t-amylalcohol, 1-(2-hydroxy-2-methylpropoxy)-4-hydroxy-2,2,6,6-tetramethylpiperidine, 1-(2-hydroxy-2-methylpropoxy)-4-oxo-2,2,6,6-tetramethylpiperidine, bis(1-(2-hydroxy-2-methylpropoxy)-2,2,6,6-tetramethylpiperidin-4-yl)sebacate, bis(1-(2-hydroxy-2-methylpropoxy)-2,2,6,6-tetramethylpiperidin-4-yl)adipate, bis(1-(2-hydroxy-2-methylpropoxy)-2,2,6,6-tetramethylpiperidin-4-yl)succinate, bis(1-(2-hydroxy-2-methylpropoxy)-2,2,6,6-tetramethylpiperidin-4-yl)glutarate and 2,4-bis{N-[1-(2-hydroxy-2-methylpropoxy)-2,2,6,6-tetramethylpiperidin-4-yl]-N-butylamino}-6-(2-hydroxyethyl-amino)-s-triazine.

2.8. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.9. Tris-aryl-o-hydroxyphenvl-s-triazines, for example known commercial tris-aryl-o-hydroxyphenyl-s-triazines and triazines as disclosed in, WO 96/28431, EP 434608, EP 941989, GB 2,317,893, U.S. Pat. Nos. 3,843,371; 4,619,956; 4,740,542; 5,096,489; 5,106,891; 5,298,067; 5,300,414; 5,354,794; 5,461,151; 5,476,937; 5,489,503; 5,543,518; 5,556,973; 5,597,854; 5,681,955; 5,726,309; 5,942,626; 5,959,008; 5,998,116 and 6,013,704, for example 4,6-bis-(2,4-dimethylphenyl)-2-(2-hydroxy-4-octyloxyphenyl)-s-triazine, Cyasorb® 1164, Cytec Corp, 4,6-bis-(2,4-dimethylphenyl)-2-(2,4-dihydroxyphenyl)-s-triazine, 2,4-bis(2,4-dihydroxyphenyl)-6-(4-chlorophenyl)-s-triazine, 2,4-bis[2-hydroxy-4-(2-hydroxyethoxy)phenyl]-6-(4-chlorophenyl)-s-triazine, 2,4-bis[2-hydroxy-4-(2-hydroxy-4-(2-hydroxyethoxy)phenyl]-6-(2,4-dimethylphenyl)-s-triazine, 2,4-bis[2-hydroxy-4-(2-hydroxyethoxy)phenyl]-6-(4-bromophenyl)-s-triazine, 2,4-bis[2-hydroxy-4-(2-acetoxyethoxy)phenyl]-6-(4-chlorophenyl)-s-triazine, 2,4-bis(2,4-dihydroxyphenyl)-6-(2,4-dimethylphenyl)-s-triazine, 2,4-bis(4-biphenylyl)-6-(2-hydroxy-4-octyloxycarbonylethylideneoxyphenyl)-s-triazine, 2-phenyl-4-[2-hydroxy-4-(3-sec-butyloxy-2-hydroxypropyloxy)phenyl]-6-[2-hydroxy-4-(3-sec-amyloxy-2-hydroxypropyloxy)-phenyl]-s-triazine, 2,4-bis(2,4-dimethylphenyl)-6-[2-hydroxy-4-(3-benzyloxy-2-hydroxy-propyloxy)phenyl]-s-triazine, 2,4-bis(2-hydroxy-4-n-butyloxyphenyl)-6-(2,4-di-n-butyloxyphenyl)-s-triazine, 2,4-bis(2,4-dimethylphenyl)-6-[2-hydroxy-4-(3-nonyloxy*-2-hydroxypropyloxy)-5-α-cumylphenyl]-s-triazine (* denotes a mixture of octyloxy, nonyloxy and decyloxy groups), methylenebis-{2,4-bis(2,4-dimethylphenyl)-6-[2-hydroxy-4-(3-butyloxy-2-hydroxypropoxy)-phenyl]-s-triazine}, methylene bridged dimer mixture bridged in the 3:5′, 5:5′ and 3:3′ positions in a 5:4:1 ratio, 2,4,6-tris(2-hydroxy-4-isooctyloxycarbonylisopropylideneoxyphenyl)-s-triazine, 2,4-bis(2,4-dimethylphenyl)-6-(2-hydroxy-4-hexyloxy-5-α-cumylphenyl)-s-triazine, 2-(2,4,6-trimethyl-phenyl)-4,6-bis[2-hydroxy-4-(3-butyloxy-2-hydroxypropyloxy)phenyl]-s-triazine, 2,4,6-tris[2-hydroxy-4-(3-sec-butyloxy-2-hydroxypropyloxy)phenyl]-s-triazine, mixture of 4,6-bis-(2,4-dimethylphenyl)-2-(2-hydroxy-4-(3-dodecyloxy-2-hydroxypropoxy)-phenyl)-s-triazine and 4,6-bis-(2,4-dimethylphenyl)-2-(2-hydroxy-4-(3-tridecyloxy-2-hydroxypropoxy)-phenyl)-s-triazine, Tinuvine® 400, Ciba Specialty Chemicals Corp., 4,6-bis-(2,4-dimethylphenyl)-2-(2-hydroxy-4-(3-(2-ethylhexyloxy)-2-hydroxypropoxy)-phenyl)-s-triazine and 4,6-diphenyl-2-(4-hexyloxy-2-hydroxyphenyl)-s-triazine.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosphites and phosphonites, for example triphenyl phosphite, diphenyl alkyl phosphites, phenyl dialkyl phosphites, tris(nonylphenyl)phosphite, trilauryl phosphite, trioctadecyl phosphite, distearyl pentaerythritol diphosphite, tris(2,4-di-tert-butylphenyl)phosphite, diisodecyl pentaerythritol diphosphite, bis(2,4-di-tert-butylphenyl)pentaerythritol diphosphite, bis(2,6-di-tert-butyl-4-methylphenyl)-pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl)4,4′-biphenylene diphosphonite, 6-isooctyloxy-2,4,8,10-tetra-tert-butyl-dibenzo[d,f][1,3,2]dioxaphosphepin, 6-fluoro-2,4,8,10-tetra-tert-butyl-12-methyl-dibenzo[d,g][1,3,2]dioxaphosphocin, bis(2,4-di-tert-butyl-6-methylphenyl)methyl phosphite, bis(2,4-di-tert-butyl-6-methylphenyl)ethyl phosphite, 2,2′,2″-nitrilo[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite.

Especially preferred are the following phosphites:
Tris(2,4-di-tert-butylphenyl)phosphite (Irgafos®168, Ciba Specialty Chemicals Corp.), tris(nonylphenyl) phosphite,

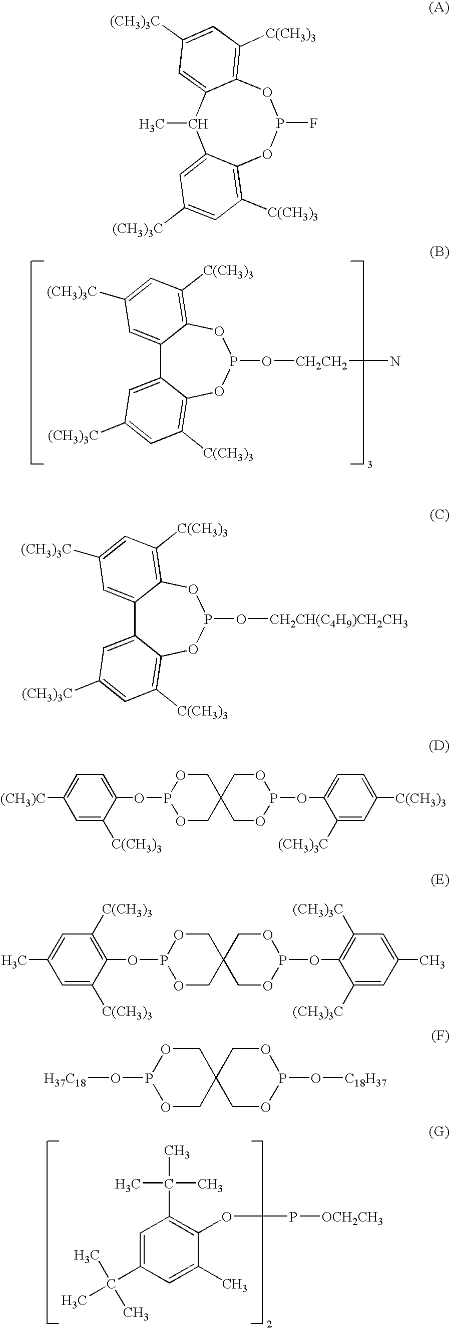

5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxyl-amine, N-heptadecyl-N-octadecylhydroxylamine, N-methyl-N-octadecylhydroxylamine and the N,N-dialkylhydroxylamine derived from hydrogenated tallow amine.

6. Nitrones, for example N-benzyl-α-phenyinitrone, N-ethyl-α-methylnitrone, N-octyl-α-heptylnitrone, N-lauryl-α-undecylnitrone, N-tetradecyl-α-tridcyinitrone, N-hexadecyl-α-pentadecylnitrone, N-octadecyl-α-heptadecylnitrone, N-hexadecyl-α-heptadecylnitrone, N-ocatadecyl-α-pentadecyinitrone, N-heptadecyl-α-heptadecylnitrone, N-octadecyl-α-hexadecylnitrone, N-methyl-α-heptadecyinitrone and the nitrone derived from N,N-dialkylhydroxylamine derived from hydrogenated tallow amine.

7. Amine oxides, for example amine oxide derivatives as disclosed in U.S. Pat. Nos. 5,844,029 and 5,880,191, didecyl methyl amine oxide, tridecyl amine oxide, tridodecyl amine oxide and trihexadecyl amine oxide.

8. Benzofuranones and indolinones, for example those disclosed in U.S. Pat. Nos. 4,325,863, 4,338,244, 5,175,312, 5,216,052, 5,252,643; DE-A-4316611; DE-A-4316622; DE-A-4316876; EP-A-0589839 or EP-A-0591102 or 3-[4-(2-acetoxyethoxy)-phenyl]-5,7-di-tert-butyl-benzofuran-2-one, 5,7-di-tert-butyl-3-[4-(2-stearoyloxyethoxy)phenyl]-benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butyl-benzofuran-2-one, 3-(3,5-dimethyl-4-pivaloyloxyphenyl)-5,7-di-tert-butyl-benzofuran-2-one, 3-(3,4-dimethylphenyl)-5,7-di-tert-butyl-benzofuran-2-one, 3-(2-acetyl-5-isooctylphenyl)-5-isooctylbenzofuran-2-one, and 3-(2,3-dimethylphenyl)-5,7-di-tert-butyl-benzofuran-2-one.

9. Thiosynergists, for example dilauryl thiodipropionate or distearyl thiodipropionate.

10. Peroxide scavengers, for example esters of β-thiodipropionic acid, for example the lauryl, stearyl, myristyl or tridecyl esters, mercaptobenzimidazole or the zinc salt of 2-mercapto-benzimidazole, zinc dibutyldithiocarbamate, dioctadecyl disulfide, pentaerythritol tetrakis(β-dodecylmercapto)propionate.

11. Polyamide stabilizers, for example copper salts in combination with iodides and/or phosphorus compounds and salts of divalent manganese.

12. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example, calcium stearate, zinc stearate, magnesium behenate, magnesium stearate, sodium ricinoleate and potassium palmitate, antimony pyrocatecholate or zinc pyrocatecholate.

13. Nucleating agents, for example inorganic substances such as talcum, metal oxides such as titanium dioxide or magnesium oxide, phosphates, carbonates or sulfates of, preferably, alkaline earth metals; organic compounds such as mono- or polycarboxylic acids and the salts thereof, e.g. 4-tert-butylbenzoic acid, adipic acid, diphenylacetic acid, sodium succinate or sodium benzoate; polymeric compounds such as ionic copolymers (ionomers).

14. Fillers and reinforcing agents, for example calcium carbonate, silicates, glass fibres, glass bulbs, asbestos, talc, kaolin, mica, barium sulfate, metal oxides and hydroxides, carbon black, graphite, wood flour and flours or fibers of other natural products, synthetic fibers.

15. Dispersing Agents, such as polyethylene oxide waxes or mineral oil.

16. Other additives, for example plasticizers, lubricants, emulsifiers, pigments, dyes, optical brighteners, rheology additives, catalysts, flow-control agents, slip agents, crosslinking agents, crosslinking boosters, halogen scavengers, smoke inhibitors, flameproofing agents, antistatic agents, clarifiers such as substituted and unsubstituted bisbenzylidene sorbitols, benzoxazinone UV absorbers such as 2,2′-p-phenylene-bis(3,1-benzoxazin-4-one), Cyasorb® 3638 (CAS #18600-59-4), and blowing agents.

The wettable fabrics produced from the fibers or filaments of this invention are particularly useful, for example, as the skin contacting inner lining fabric of sanitary articles of manufacture, particularly single use diapers, training pants, feminine hygiene products or incontinence care products. The fabrics also have utility in articles of manufacture such as wet and dry wipes, wound dressings, surgical capes, filter medial, battery separators, and the like.

The structure of diapers are described for example in U.S. Pat. Nos. 5,149,576, 5,961,504, 6,031,147 and 6,110,849, all incorporated herein by reference.

In addition, it is often desirable to impart wettability to melt extruded polyolefin films. Such films, in perforated form, are widely used as cover sheets for sanitary articles.

For coverstock for sanitary articles, improvements in wetback properties can be improved by the use of two or more layers of fabric bonded together. Examples include two spunbond layers or an SMS fabric in which the meltblown layer is devoid of the present additives.

In addition to fabrics, polyester films, plaques, sheets and molded articles are also provided with excellent wettability according to the present invention.

Accordingly, also subject of the present invention is a wettable polyester film, plaque, sheet or molded article,

which film, plaque, sheet or molded article comprises a melt blend which comprises

a polyester and one or more compounds of components a), b), c), d) and e).

It is further contemplated that the list of metals M may be expanded so that other sulfonate-metal salts are included. For instance, the metal M may be selected from the group consisting of Li, Na, K, Cs, Be, Ca, Mg, Sr, Ba, Al, Sb, Cd, Mn, Fe, Co, Ni, Cu and Zn. In each case, the compounds of components a), b), c), d) and e) are electrically neutral.

For instance the following complexes of e) are included:

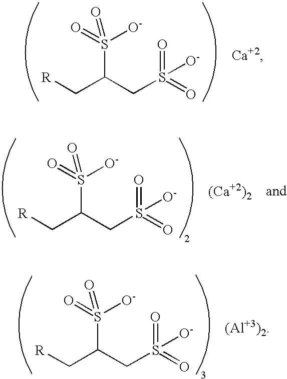

The following Examples further illustrate the invention. Unless otherwise indicated, amounts are reported as weight percent.

### SYNTHETIC EXAMPLES

### Example 1

### sodium 4-benzyloxy-butane-1-sulfonate

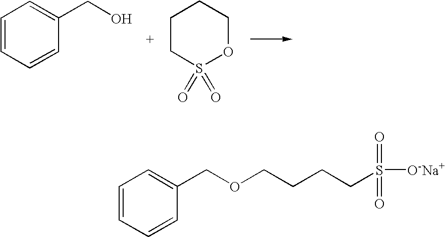

In a 2 liter round bottom flask, 26.63 g of sodium hydride (60%) and 600 mL of dry dimethyl formamide are added and stirred. 60.00 g of benzyl alcohol is added to the reaction mixture, with stirring, under N₂ atmosphere at room temperature over period of 1 h. The reaction mixture is further stirred for 0.5 h. Thereafter, 90.55 g of 1,4-butane sultone is added slowly to the reaction mixture with stirring for 2 h. The reaction mixture is then stirred overnight. At the end of the reaction, the reaction mass is poured into 2.5 liter of 2-propanol with vigorous stirring. Product is filtered, washed with 500 mL of 2-propanol and 500 mL of hexane. Product is then purified by recrystallization using methanol and dried under vacuum. Yield obtained is 45%.

### Example 2

### sodium 4-phenethyloxy-butane-1-sulfonate

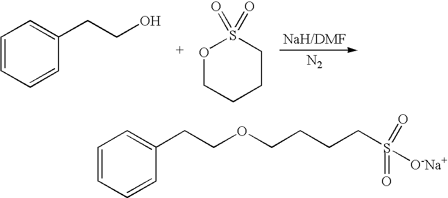

In a 1 liter three neck round bottom flask, 400 ml dry dimethyl formamide are supplied and 13.10 g sodium hydride (60%) are added. This mixture is stirred for 0.5 h under N₂ atmosphere at room temperature. A solution of 40 g of 2-phenyl ethanol in 60 ml dry dimethyl formamide is added dropwise to the reaction mixture under stirring during 2 h at room temperature. Then a solution of 44.58 g of 1,4-butane sultone in 60 ml dry dimethyl formamide is added drop by drop to the reaction mixture with stirring during 3 h. The reaction mixture is kept for overnight stirring at room temperature. At the end of the reaction, the solvent is evaporated under vacuum and the residue is treated with 1.5 liter of 2-propanol, stirred for 15 minutes and filtered. The wet cake is again treated with 2-propanol to remove unreacted starting materials. The wet cake is dried under vacuum to yield an off-white solid which is characterized by NMR. The NMR showed presence of 9.65% of allyl impurities.

In order to remove the allyl impurities, 36.70 g of compound are dissolved in 150 ml of distilled water and the solution is kept for heating at 50° C. with stirring. To this solution, 1.36 g sodium bisulfite and 10 mg of potassium persulfate are added and stirring is continued overnight at 50° C. The solvent is removed under vacuum and solid is dried under vacuum which is characterized by IR and NMR. The NMR spectrum showed that the allyl impurities are reduced to 3.06% after sodium bisulfite treatment. The yield is 42.9%.

### Example 3

### sodium 4-(3-phenyl-propoxy)-butane-1-sulfonate

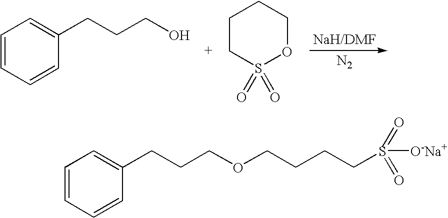

In a 1 liter three neck round bottom flask, 300 ml dry dimethyl formamide and 10.14 g sodium hydride (60%) are placed and stirred for 0.5 h under N₂ atmosphere at room temperature. 40.00 g of 3-phenyl propanol is added dropwise to the reaction mixture under stirring during 0.5 h at room temperature. The reaction mixture is continued to stir for another 0.5 h. Thereafter, 44.58 g of 1,4-butane sultone is added dropwise to the reaction mixture with stirring during 0.75 h. The reaction mixture is kept stirring for 3 h at room temperature. At the end of the reaction, the solvent is evaporated under vacuum and the residue is treated with 3.5 liter of 2-propanol, stirred for 20 minutes and filtered. The wet cake is again treated with 2-propanol to remove unreacted starting materials. The wet cake is dried under vacuum to yield an off-white solid which is characterized by NMR. The NMR showed presence of 15% of allyl impurities.

In order to remove the allyl impurities, 30.20 g of compound are dissolved in 150 ml of distilled water and the solution is kept for heating at 50° C. with stirring. To this solution, 1.76 g sodium bisulfite and 50 mg of potassium persulfate are added and stirring is continued overnight. The solvent is removed under vacuum and solid is dried under vacuum which is characterized by IR and NMR. The NMR spectrum showed that the allyl impurities are reduced to 3.10% after sodium bisulfite treatment. The yield is 64.6%.

### Example 4

### sodium 4-(4-phenyl-butoxy)-butane-1-sulfonate

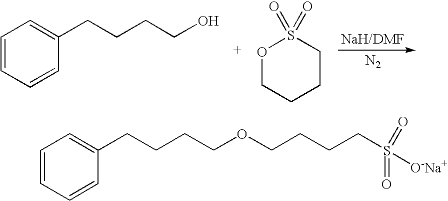

In a 1 liter three neck round bottom flask, 500 ml dry dimethyl formamide and 14.53 g sodium hydride (60%) are placed and stirred for 0.5 h under N₂ atmosphere. A solution of 54.60 g of 4-phenyl-1-butanol in 100 ml dry dimethyl formamide is added dropwise to the reaction mixture under stirring during 2 h at room temperature. Then the solution of 49.49 g of 1,4-butane sultone in 100 ml dry dimethyl formamide is added drop by drop to the reaction mixture with stirring during 3 h. The reaction mixture is kept for overnight stirring. Then the solvent is evaporated under vacuum and the residue is treated with 2.0 liter of 2-propanol, stirred for 15 minutes and filtered. The wet cake is again treated with 2-propanol to remove unreacted starting materials. The wet cake is dried under vacuum to yield an off-white solid which is characterized by NMR. The NMR spectrum showed presence of 18.70% of allyl impurities and some impurity of 1,4-disulfonated butane.

In order to remove the allyl impurities, 89.30 g of compound are dissolved in 250 ml of distilled water and the solution is kept for heating at 50° C. with stirring. To this solution, 7.72 g sodium bisulfite and 50 mg of potassium persulfate are added and the stirring is continued overnight. The solvent is removed under vacuum and solid is dried under vacuum which is characterized by IR and NMR. The NMR spectrum showed allyl impurities are reduced to 2.00%. One more impurity is also found present in the product. This impurity of 1,4-disulfonated butane is removed by dissolving 91.00 g of the above compound in excess of methanol and then 1,2-dichloroethane is added slowly to the above solution until solution becomes turbid. The solution is filtered and filtrate is concentrated under vacuum to recover the desired product. Solid is dried under vacuum and characterized by NMR. The yield is 79.6%.

### Example 5

### polyethylene glycol methyl ether (Mn=550) with sodium butoxy sulfonate terminal groups

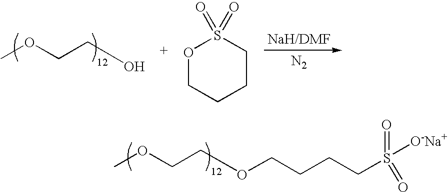

In a 1 liter three neck round bottom flask, 400 ml dry dimethyl formamide and 3.64 g sodium hydride (60%) are placed and stirred for 0.5 h under N₂ atmosphere at room temperature. A solution of 50.00 g of polyethylene glycol methyl ether (Mn=550) in 100 ml dry dimethyl formamide is added dropwise to the above solution under stirring during 2 h at room temperature. Then the solution of 12.38 g of 1,4-butane sultone in 50 ml dry dimethyl formamide is added drop by drop to the reaction mixture with stirring during 3 h. The reaction mixture is kept for overnight stirring at room temperature. Then the solvent is evaporated under vacuum and the residue is dissolved in 2.0 liter of ethyl acetate. Thereafter, hexane is added slowly until compound gets precipitated from the solution. Then the product is filtered and dried under vacuum to get pale yellow semi-solid which is characterized by NMR. The NMR showed presence of 10.00% of allyl impurities.

In order to remove the allyl impurities, 37.40 g of compound are dissolved in 150 ml of distilled water and the solution is kept for heating at 50° C. with stirring. To this solution 0.55 g sodium bisulfite and 10 mg of potassium persulfate are added and stirring is continued overnight. The solvent is removed under vacuum and solid is dried under vacuum which is characterized by IR and NMR. The NMR spectrum showed allyl impurities are reduced to 3.50% after sodium bisulfite treatment. The yield is 58.1%.

### Example 6

### sulfonate from 1-octanol and 1,4-butane sulfone

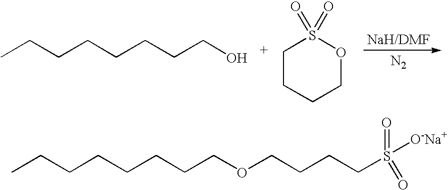

In a 1 liter three neck round bottom flask, 300 ml dry dimethyl formamide and 7.68 g sodium hydride (60%) are placed and stirred for 0.5 h under N₂ atmosphere at room temperature. A solution of 25.00 g of 1-octanol in 50 ml dry dimethyl formamide is added dropwise to the above solution under stirring during 2 h at room temperature. Then the solution of 23.53 g of 1,4-butane sultone in 50 ml dry dimethyl formamide is added drop by drop to the reaction mixture with stirring during 3 h. The reaction mixture is kept for overnight stirring at room temperature. Then the solvent is evaporated under vacuum and the residue is treated with 1.5 liter of 2-propanol. The product is filtered and dried under vacuum to get white solid which is characterized by NMR. The NMR showed presence of 13.36% of allyl impurities. In order to remove the allyl impurities, 43.3 g of compound is dissolved in 150 ml of distilled water and the solution is kept for heating at 50° C. with stirring. To this solution 2.19 g sodium bisulfite and 20 mg of potassium persulfate are added and stirring is continued overnight. The solvent is removed under vacuum and solid is dried under vacuum which is characterized by IR and NMR. The NMR spectrum showed allyl impurities are reduced to 2.48% after sodium bisulfite treatment. The yield is 75.2%.

### Example 7

### Preparation of octadecane-1,2-disulfonic acid di-sodium salt

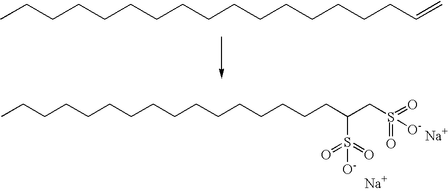

In a 1 liter single neck round bottom flask, 25 g of octadec-1-ene, 25.8 g of sodium bisulfite and 0.25 g of 2,6-di-tert-butyl-4-methyl-phenol are taken. To this mixture, 250 ml 2-propanol and 250 ml distilled water are added and reaction mixture is heated to 50° C. with stirring. Thereafter, 1.5 ml of tertiary butyl perbenzoate is added to this reaction mixture and kept for 24 h stirring at 50° C. The solvent is removed under vacuum and compound is dried under vacuum at 60° C. for 12 h. The product (disodium; octadecane-1,2-disulfonate) was finally purified by column chromatography. The yield is 25.26%.

### Example 8

### Sulfoalkylation of ethoxylated alcohol

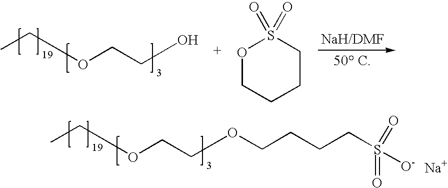

In a 5 liter three neck round bottom flask, 500 ml dry dimethyl formamide and 42.3 g sodium hydride (60%) are placed and stirred for 0.5 h under N₂ atmosphere at room temperature. A solution of 350.00 g of ethoxylated alcohol (Imbentin AG/200/025) in 2000 ml dry dimethyl formamide is added dropwise to the above solution under stirring during 1 h at 50° C. and this solution is kept stirring at 50° C. for another 3 hours. Then the solution of 121.72 g of 1,4-butane sultone in 500 ml dry dimethyl formamide is added drop by drop to the reaction mixture with stirring during 3 h. The reaction mixture is kept for overnight stirring at 50° C. Then the solvent is evaporated under vacuum and the residue is treated with 4 liter of 2-propanol and filtered. Residue is further washed with 2 liter of 2-propanol. The product is then dried under vacuum to get white powder which is characterized by NMR. The yield is 65.86%.

### Application Example 1

Additive compounds are dry blended with a commercial fiber grade (ca. 0.65 iv) PET resin, with a total batch size of 1000 g prior to compounding on a twin screw extruder. Alternatively, concentrates are prepared and blended with PET resin at a proper ratio to obtain the target concentration. Concentration is weight percent additive based on weight of PET. The blended resins are crystallized, dried, and processed under an Ar purge on a research scale meltblown line with a 6″ die to produce nonwoven fabrics. The melt and air temperatures are set to approximately 305° C. The air flow is adjusted so as not to form fly when the PET is run without additive. The target basis weight of the nonwoven web is 80 gsm.

The table below contains results for where the hydrophilic additives are one of Synthetic Examples 1-6. Measured is the time it takes for a 0.9% NaCl/water solution to pass through the sample fabric (liquid strike through time, EDANA 150.5-02). Times above 50 seconds are considered non-viable, between 10 and 50 seconds are considered moderately active and less than 10 seconds are considered highly active.

| Synthetic Example | concentration | strike-through time (sec) |
|---|---|---|
| 1 | 0.10 | 5.5 |
| 1 | 0.25 | 5.0 |
| 1 | 0.50 | 2.5 |
| 2 | 2.5 | 2.8 |
| 3 | 2.5 | 2.9 |
| 4 | 0.25 | 12 |
| 4 | 0.50 | 3.4 |
| 4 | 1.0 | 2.3 |
| 4 | 2.5 | 2.2 |
| 5 | 0.50 | 15 |
| 6 | 0.50 | 3.8 |

What is claimed is:

1. A polyester fiber or filament comprising a melt blend of a polyester and one or more compounds selected from the group consisting of
a) phenylalkyl-oxy-alkyl metal sulfonates of the formula 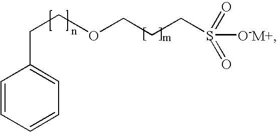
b) alkyl-oxy-alkyl metal sulfonates of the formula 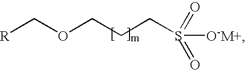
c) polyethyleneoxy-alkyl metal sulfonates of the formula 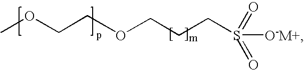
d) alkyl-polyethyleneoxy-alkyl metal sulfonates of the formula 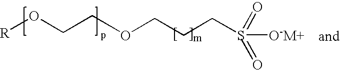
e) alkyl-1,2-disulfonate metal sulfonates 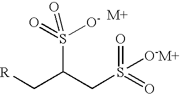
where
m is 0, 1 or 2,
n is an integer from 1 to 6,
p is an integer from 1 to 16,
R is alkyl of 1 to 24 carbon atoms and
M is Na, K or Li.

2. A polyester fiber or filament according to claim 1 comprising one or more phenylalkyl-oxy-alkyl metal sulfonates of component a).

3. A polyester fiber or filament according to claim 1 comprising one or more alkyl-oxy-alyl metal sulfonates of component b).

4. A polyester fiber or filament according to claim 1 comprising one or more polyethyleneoxy-alkyl metal sulfonates of component c).

5. A polyester fiber or filament according to claim 1 comprising one or more polyethyleneoxy-alkyl metal sulfonates of component d).

6. A polyester fiber or filament according to claim 1 comprising one or more polyethyleneoxy-alkyl metal sulfonates of component e).

7. A fiber or filament according to claim 1, in which the polyester is poly(ethylene terephthalate), poly(ethylene2,6-naphthalene-2,6-dicarboxylate) or poly(lactic acid).

8. A fiber or filament according to claim 1, in which the polyester is poly(ethylene terephthalate).

9. A fiber or filament according to claim 1, in which the compounds a), b), c), d) and e) are present from about 0.05% to about 5.0% by weight, based on the weight of the polyester.

10. A fiber or filament according to claim 1, in which the compounds a), b), c), d) and e) are present from about 0.1% to about 1.0%, based on the weight of the polyester.

11. A wettable knit, woven or nonwoven fabric produced from the fibers or filaments of claim 1.

12. An article of manufacture prepared from a wettable fabric according to claim 11 selected from the group consisting of single use diapers, training pants, feminine hygiene products, incontinence care products, wet or dry wipes, wound dressings, surgical capes, filter medial and battery separators.

13. A method for imparting wettability to a polyester fiber or filament, which method comprises melt extruding a mixture which comprises
a polyester and one or more compounds selected from the group consisting of
a) phenylalkyl-oxy-alkyl metal sulfonates of the formula 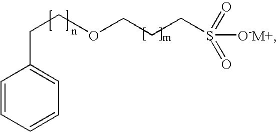
b) alkyl-oxy-alkyl metal sulfonates of the formula 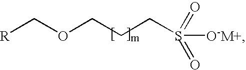
c) polyethyleneoxy-alkyl metal sulfonates of the formula 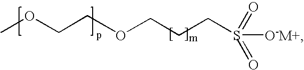
d) alkyl-polyethyleneoxy-alkyl metal sulfonates of the formula 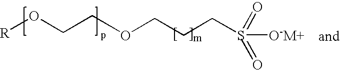
e) alkyl-1,2-disulfonate metal sulfonates 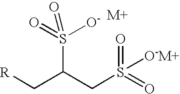
where
m is 0, 1 or 2,
n is an integer from 1 to 6,
p is an integer from 1 to 16,
R is alkyl of 1 to 24 carbon atoms and
M is Na, K or Li.
into a plurality of fibers or filaments and cooling the fibers or filaments.

14. A method according to claim 13, which comprises
preparing a masterbatch comprising one or more compounds of a), b), c), d) and e) and a first polymer and
melt extruding a mixture which comprises said masterbatch and a polyester
into a plurality of fibers or filaments and cooling the fibers or filaments.
